(19) United States
(12) Patent Application Publication
(10) Pub. No.: US 2025/0307284 A1
(43) Pub. Date: Oct. 2, 2025

(54) INFORMATION PROCESSING

(71) Applicant: TENCENT TECHNOLOGY (SHENZHEN) COMPANY LIMITED, Shenzhen (CN)

(72) Inventors: Chuangmu YAO, Shenzhen (CN); Yuwei HAN, Shenzhen (CN); Hang ZHAO, Shenzhen (CN); Xiaosi LAI, Shenzhen (CN); Sixing LIU, Shenzhen (CN); Lingyuan GUO, Shenzhen (CN); Yue SHU, Shenzhen (CN); Fan WANG, Shenzhen (CN); Hailiang MA, Shenzhen (CN)

(73) Assignee: TENCENT TECHNOLOGY (SHENZHEN) COMPANY LIMITED, Shenzhen (CN)

(21) Appl. No.: 19/237,879

(22) Filed: Jun. 13, 2025

Related U.S. Application Data
(63) Continuation of application No. PCT/CN2023/135279, filed on Nov. 30, 2023.

(30) Foreign Application Priority Data
May 16, 2023 (CN) 202310552381.3

(51) Int. Cl. G06F 16/3332; G06F 16/338; G06F 16/38

(52) U.S. Cl. CPC G06F 16/3334; G06F 16/338; G06F 16/382

(57) ABSTRACT

In some examples, a first message is displayed in a session interface in response to a message transmission operation. In the session interface, a second message that replies to the first message is displayed. The second message includes one or more pieces of key information and respective citation tags of the one or more pieces of key information. The one or more pieces of key information are obtained from search results associated with the citation tags. Further, in a citation interface and in response to a trigger operation on a first target citation tag of a target piece of key information, first information that is obtained from a first location of a first target search result associated with the first target citation tag is displayed. The first information includes the target piece of key information in the second message. Apparatus and non-transitory computer-readable storage medium counterpart embodiments are also contemplate.

### RELATED APPLICATIONS

The present application is a continuation of International Application No. PCT/CN2023/135279, filed on Nov. 30, 2023, which claims priority to Chinese Patent Application No. 202310552381.3, filed on May 16, 2023. The entire disclosures of the prior applications are hereby incorporated by reference.

### FIELD OF THE TECHNOLOGY

This disclosure relates to computer technologies, including to an information processing method and apparatus, an electronic device, a computer-readable storage medium, and a computer program product.

### BACKGROUND OF THE DISCLOSURE

With rapid development of Internet technologies, a search technology is no longer completely bound to a search scenario, and the search technology may also be used in an intelligent session scenario. For a first message input by a user, after intention identification is performed on the first message, the first message identified may be used as a search basis, and the first message is replied to based on a search result by using a second message.

However, the second message provided in the related art can provide a limited amount of information, and cannot meet a requirement of intending to understand more information further, or the user may suspect credibility of the second message. This requires the user to continue to initiate a plurality of subsequent session interactions.

There is still no effective solution in the related art to improve human-computer interaction efficiency in a human-computer session.

### SUMMARY

Embodiments of this disclosure provide an information processing method and apparatus, an electronic device, a computer-readable storage medium, and a computer program product, which can improve human-computer interaction efficiency during a session.

Some aspects of the disclosure provide a method of information processing. For example, a first message is displayed in a session interface in response to a message transmission operation. In the session interface, a second message that replies to the first message is displayed. The second message includes one or more pieces of key information and respective citation tags of the one or more pieces of key information. The one or more pieces of key information are obtained from search results associated with the citation tags. Further, in a citation interface and in response to a trigger operation on a first target citation tag of a target piece of key information in the one or more pieces of key information, first information that is obtained from a first location of a first target search result associated with the first target citation tag is displayed. The first information at the first location of the first target search result includes the target piece of key information in the second message.

Some aspects of the disclosure provide an information processing apparatus that includes processing circuitry configured to perform the method of information processing.

Some aspects of the disclosure also provide a non-transitory computer-readable storage medium storing instructions which when executed by at least one processor cause the at least one processor to perform the method of information processing.

In some aspects, technical solutions of the embodiments of this disclosure are implemented as follows. An embodiment of this disclosure provides an information processing method, including: displaying a session interface; displaying a first message in the session interface in response to a message transmission operation, and displaying, in the session interface, a second message for replying to the first message; the second message including key information for replying to the first message and a citation tag of each piece of key information, and the key information being corresponding to a search result associated with the citation tag; and displaying, in a citation interface, information at a first location in a target search result in response to a trigger operation for a target citation tag; the information at the first location including target key information, and the target key information being key information corresponding to the target citation tag.

In some aspects, an embodiment of this disclosure provides an information processing apparatus, including: a display module, configured to display a session interface; a session module, configured to display a first message in the session interface in response to a message transmission operation, and display, in the session interface, a second message for replying to the first message; the second message including key information for replying to the first message and a citation tag of each piece of key information, and the key information being corresponding to a search result associated with the citation tag; and a jump module, configured to display, in a citation interface, information at a first location in a target search result in response to a trigger operation for a target citation tag; the information at the first location including target key information, and the target key information being key information corresponding to the target citation tag.

In some aspects, an embodiment of this disclosure provides an electronic device, including: a memory, configured to store computer-executable instructions; and a processor (an example of processing circuitry), configured to execute the computer-executable instructions stored in the memory to implement the information processing method according to the embodiments of this disclosure.

An embodiment of this disclosure provides a computer-readable storage medium (e.g., non-transitory computer-readable storage medium), storing computer-executable instructions, configured for, when executed by a processor, implementing the information processing method according to the embodiments of this disclosure.

An embodiment of this disclosure provides a computer program product, including computer-executable instructions, the computer-executable instructions, when executed by a processor, implementing the information processing method according to the embodiments of this disclosure.

The embodiments of this disclosure have the following beneficial effects.

According to the embodiments of this disclosure, a citation tag of key information may be displayed in a second message when a first message is automatically replied to, so that a user can view, by using the citation tag, a search result from which the key information is derived, and can locate a location of the key information in the search result for display. In this way, the user does not need to flip up and down in the search result to find the key information, thereby improving information obtaining efficiency and human-computer interaction efficiency.

### BRIEF DESCRIPTION OF THE DRAWINGS

FIG. 1 is a schematic diagram of an architecture of an information processing system according to an embodiment of this disclosure.

FIG. 2 is a schematic structural diagram of an electronic device according to an embodiment of this disclosure.

FIG. 3A to FIG. 3D are each a schematic flowchart of an information processing method according to an embodiment of this disclosure.

FIG. 4A to FIG. 4D are each a schematic interface diagram of an information processing method according to an embodiment of this disclosure.

FIG. 5A to FIG. 5C are each a schematic interface diagram of an information processing method according to an embodiment of this disclosure.

FIG. 6 is a schematic flowchart of an information processing method according to an embodiment of this disclosure.

FIG. 7 is a schematic diagram of an architecture of an information processing method according to an embodiment of this disclosure.

### DESCRIPTION OF EMBODIMENTS

The following describes technical solutions in embodiments of this disclosure with reference to the accompanying drawings. The described embodiments are some of the embodiments of this disclosure rather than all of the embodiments. Other embodiments are within the scope of this disclosure.

Examples of terms involved in the aspects of the disclosure are briefly introduced. The descriptions of the terms are provided as examples only and are not intended to limit the scope of the disclosure.

In the following description, the involved terms “first\second\third” are merely intended to distinguish between similar objects and do not represent a specific order of objects. “First\second\third” can be interchanged in a specific order or sequential order if allowed, so that the embodiments of this disclosure described herein can be implemented in an order other than that illustrated or described herein.

Unless otherwise defined, meanings of all technical and scientific terms used in this specification are the same as those usually understood by a person skilled in the art to which this disclosure belongs. Terms used herein are merely intended to describe the embodiments of this disclosure, but are not intended to limit this disclosure.

Before the embodiments of this disclosure are further described in detail, a description is made on nouns and terms in the embodiments of this disclosure, and the nouns and terms in the embodiments of this disclosure are applicable to the following explanations.
1) Response represents a condition or state upon which performed operations depend, where one or more of the performed operations may be real-time or may have a set delay when the dependent condition or state is satisfied. Without being specifically stated, there is no limitation to the order in which the operations are performed.
2) First message: The first message includes all information generated during a session (for example, a scenario such as a chat or a consultation), including text, an image, a video, a voice file, and the like. The first message may be a particular first message, for example, “How to breed crayfish”. The first message may alternatively be a message with an intention of asking a question, for example, “Learn to hit a flying disc”, which may be recognized as actually asking how to hit a flying disc.
3) A citation tag is an tag for representing a citation source of information. For example, if a citation tag after a piece of information is “1”, it represents that a reference source of the information is a citation source whose number is 1.
4) Source link: The source link is a trigger entry, a web page or a document (a citation source) can be jumped to by triggering the source link, and each citation tag has its respective source link. For example, a citation tag after a piece of information is “1”, and the citation tag 1 corresponds to the source link. In this case, the web page can be jumped to by triggering the source link, and the information is displayed on the web page.

In the related art, a terminal receives a first message input by a user. For example, the first message is a specific first message A. A server generates query information (query) according to the first message A, performs a search based on the query information, obtains a search result, generates an answer according to the search result, and returns the answer as a second message to the terminal used by the user.

The embodiments of this disclosure provide an information processing method and apparatus, an electronic device, a computer-readable storage medium, and a computer program product, which can improve information obtaining efficiency and human-computer interaction efficiency during a session.

An application of the electronic device provided in the embodiments of this disclosure is described below. The electronic device provided in the embodiments of this disclosure may be implemented as various types of user terminals such as a notebook computer, a tablet computer, a desktop computer, a set-top box, a mobile device (for example, a mobile phone, a portable music player, a personal digital assistant, a dedicated messaging device, or a portable game device), a smart voice interaction device, a smart home appliance, an in-vehicle terminal, or an aircraft.

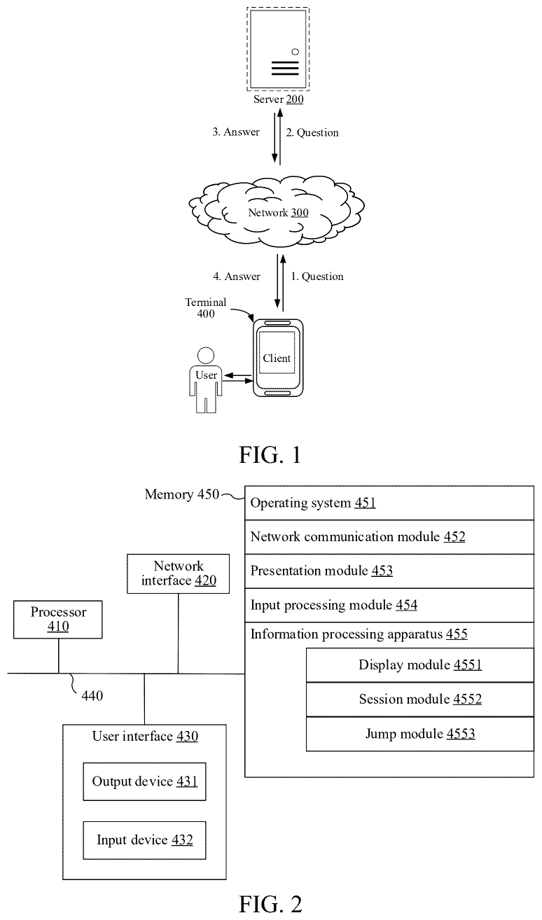

Referring to FIG. 1, FIG. 1 is a schematic structural diagram of an information processing system according to an embodiment of this disclosure. To support a social application, a terminal 400 is connected to a server 200 through a network 300. The network 300 may be a wide area network, a local area network, or a combination thereof.

In some embodiments, the terminal 400 of a target object A displays a session interface and receives a message transmission operation. A first message is displayed in the session interface of the terminal 400. The terminal 400 transmits the first message to the server 200. The server 200 obtains a second message for replying to the first message. The second message includes key information for replying to the first message and a citation tag of each piece of key information, and the key information corresponds to a search result associated with the citation tag. The server 200 returns the second message to the terminal 400 and displays the second message in the session interface of the terminal 400. The terminal 400 receives a trigger operation for a target citation tag, generates a source viewing request based on the trigger operation, and transmits the source viewing request to the server 200. The server 200 obtains a target search result corresponding to the target citation tag, and obtains a first location that is of key information corresponding to the target citation tag and that is in the target search result. The server 200 returns the first location and the target search result to the terminal 400. Information at the first location in the target search result is displayed in a citation interface of the terminal 400. The information at the first location includes target key information, and the target key information is the key information corresponding to the target citation tag.

In some embodiments, the terminal or the server may run a computer program to implement the information processing method provided in the embodiments of this disclosure. For example, the computer program may be an original program or a software module in an operating system; may be a native application (APP), that is, a program that needs to be installed in an operating system to run, such as a social network client; or may be a mini program, that is, a program only needs to be downloaded into a browser environment to run; or may be a mini program that can be embedded in any APP. In summary, the foregoing computer program may be an APP, a module, or a plugin in any form.

The embodiments of this disclosure may be implemented with the help of a cloud technology. The cloud technology is a hosting technology that unifies a series of resources such as hardware, software, and networks within a wide area network or a local area network to implement data calculation, storage, processing, and sharing.

The cloud technology is a general term for network technology, information technology, integration technology, management platform technology, and application technology that are applied based on cloud computing business modes, and can constitute a resource pool to be used as required, which is flexible and convenient. Cloud computing technology is to become an important support. Back-end services of a technology network system require a lot of computing and storage resources.

In an example, the server 200 may be an independent physical server, or may be a server cluster or a distributed system including a plurality of physical servers, or may be a cloud server providing basic cloud computing services, such as a cloud service, a cloud database, cloud computing, a cloud function, cloud storage, a network service, cloud communication, a middleware service, a domain name service, a security service, a content delivery network (CDN), big data, and an artificial intelligence platform. The terminal 400 may be, but is not limited to, a smartphone, a tablet computer, a notebook computer, a desktop computer, a smart speaker, a smartwatch, a smart voice interaction device, a smart appliance, an in-vehicle terminal, an aircraft, or the like. The terminal 400 and the server 200 may be directly or indirectly connected in a wired or wireless communication manner. This is not limited in the embodiments of this disclosure.

Referring to FIG. 2, FIG. 2 is a schematic structural diagram of an electronic device according to an embodiment of this disclosure. The terminal shown in FIG. 2 includes: at least one processor 410, a memory 450, at least one network interface 420, and a user interface 430. Components in the terminal 400 are coupled together through a bus system 440. The bus system 440 is configured to implement connection and communication between the components. In addition to a data bus, the bus system 440 also includes a power bus, a control bus, and a status signal bus. However, for clarity of description, various buses are marked as the bus system 440 in FIG. 2.

The processor 410 may be an integrated circuit chip and has a signal processing capability, for example, a general purpose processor, a digital signal processor (DSP), or another programmable logical device, a discrete gate or a transistor logical device, or a discrete hardware component. The general purpose processor may be a microprocessor, any suitable processor, or the like.

The user interface 430 includes one or more output devices 431 that enable presentation of media content, including one or more speakers and/or one or more visual display screens. The user interface 430 further includes one or more input devices 432, including user interface components that facilitate user input, such as a keyboard, a mouse, a microphone, a touchscreen, a camera, and other input buttons and controls.

The memory 450 may be removable, irremovable, or a combination thereof. In an example, a hardware device includes a solid state memory, a hard disk drive, an optical disk drive, or the like. The memory 450 in some embodiments includes one or more storage devices that are physically located away from the processor 410.

The memory 450 includes a volatile memory or a non-volatile memory, or may include both a volatile memory and a non-volatile memory. The non-volatile memory may be a read-only memory (ROM). The volatile memory may be a random access memory (RAM). The memory 450 described in this embodiment of this disclosure is intended to include any suitable type of memory.

In some embodiments, the memory 450 can store data to support various operations. Examples of the data include a program, a module, a data structure, or a subset or a superset thereof, which are described below by way of example.

An operating system 451 includes system programs configured to process various basic system services and perform hardware-related tasks, for example, a frame layer, a core library layer, and a driver layer, which are configured to implement various basic businesses and process hardware-based tasks.

A network communication module 452 is configured to reach other electronic devices via one or more (wired or wireless) network interfaces 420. The network interface 420 exemplarily includes: Bluetooth, Wi-Fi, a universal serial bus (USB), or the like.

A presentation module 453 is configured to enable presentation of information through the one or more output devices 431 (for example, a display screen or a speaker) associated with the user interface 430 (for example, a user interface configured to operate a peripheral device and display content and information).

An input processing module 454 is configured to detect one or more user inputs or interactions from one of the one or more input devices 432 and translate the detected inputs or interactions.

In some embodiments, an information processing apparatus provided in the embodiments of this disclosure may be implemented in a form of software. FIG. 2 shows an information processing apparatus 455 stored in the memory 450, which may be software in a form of programs and plug-ins, or the like, and include the following software modules: a display module 4551, a session module 4552, and a jump module 4553. These modules are logical and therefore can be arbitrarily combined or further split according to functions achieved. The functions of the modules are to be described below.

The information processing method provided in the embodiments of this disclosure is described in combination with the applications and implementations of the terminal provided in the embodiments of this disclosure.

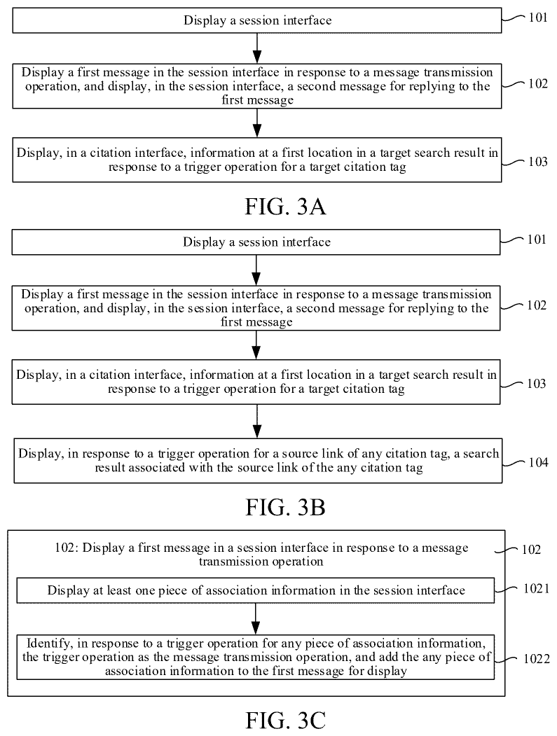

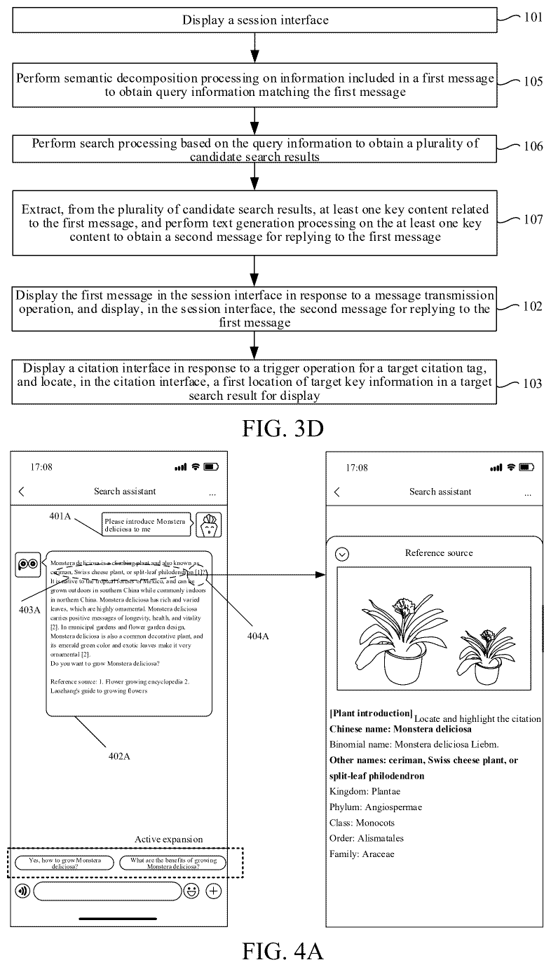

Referring to FIG. 3A, FIG. 3A is a schematic flowchart of an information processing method according to an embodiment of this disclosure. Description is provided with reference to operations 101 to 103 shown in FIG. 3A.

Operation 101: Display a session interface.

As an example, the session interface herein may be a session interface between a user account and an AI account.

Operation 102: Display a first message in the session interface in response to a message transmission operation, and display, in the session interface, a second message for replying to the first message.

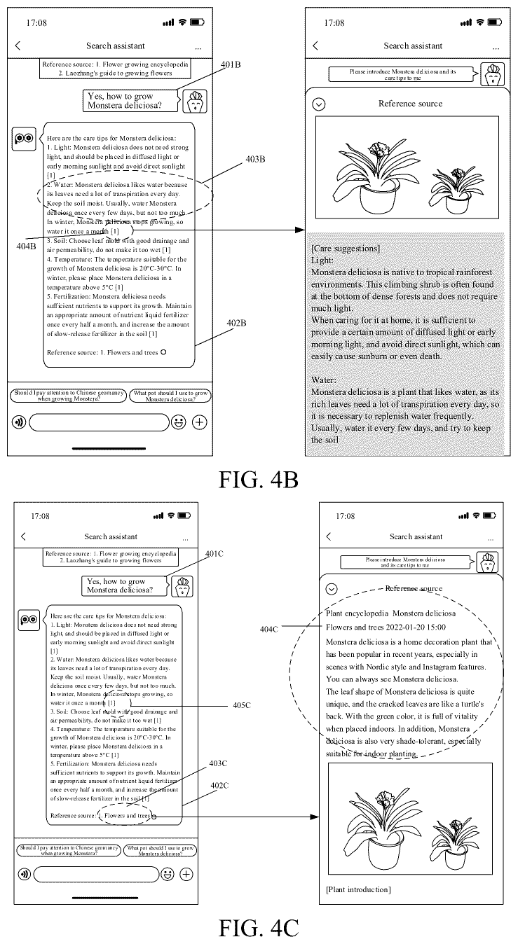

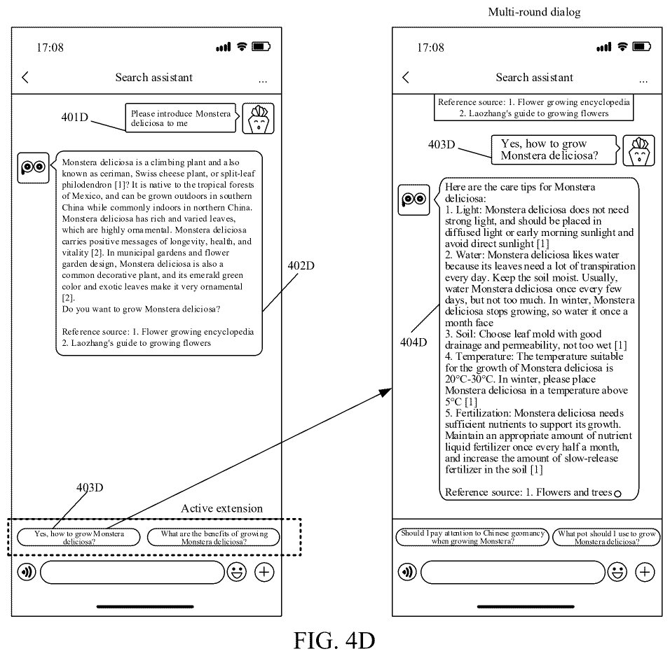

As an example, the second message includes key information for replying to the first message and a citation tag of each piece of key information, and the key information corresponds to a search result associated with the citation tag. In terms of the case that the key information corresponds to the search result associated with the citation tag, the search result herein is equivalent to a citation source represented by the citation tag, and the key information is directly derived from the search result associated with the citation tag, or the key information is obtained by performing semantic generation processing based on a key content in the search result associated with the citation tag. Referring to FIG. 4A, a question 401A and an answer 402A are displayed in a human-computer interaction interface. The answer 402A includes an answer content 403A and a citation tag 404A. The question 401A herein is session information carried in the first message in the session interface. The answer 402A herein is session information carried in the second message. The answer content 403A is key information in the session information. The key information is information that is in the second message and that is configured for replying to the first message. The citation tag 404A corresponding to the answer content 403A may annotate a citation source of the answer content 403A.

As an example, the session information in the first message may alternatively be any session sentence. For example, the session information in the first message may be “I am a little bit tired”. In this case, the session information in the second message is configured for replying to the sentence in the first message. A potential requirement of the sentence may be matched by using a natural language processing technology, and searching is performed based on the potential requirement. For example, a plurality of methods for overcoming fatigue are obtained by searching. In this way, the returned second message includes the key information at how to overcome the fatigue and the corresponding citation tag, to represent a citation source of the key information.

For example, the session information included in the first message may be text information, image information, audio information, video information, or the like. Similarly, the session information included in the second message may also be text information, image information, audio information, video information, or the like.

Operation 103: Display, in a citation interface, information at a first location in a target search result in response to a trigger operation for a target citation tag, the information at the first location including target key information, and the target key information being key information corresponding to the target citation tag.

As an example, the target search result is a search result displayed by jumping after the target citation tag is triggered. For example, the second message includes a target citation tag A, a web page may be jumped to by triggering the target citation tag A, and target key information annotated by the target citation tag is displayed on the web page. The web page herein is the target search result.

As an example, when a display size of the citation interface is less than a size threshold (for example, a size that can exactly display the information at the first location fully, for example, a height of three rows and a width of 20 characters), the information at the first location in the target search result is displayed in the citation interface. When the display size of the citation interface is greater than the size threshold, the information at the first location and information at other locations than the first location in the target search result, for example, information at adjacent locations (an upper row and a lower row) of the first location, are displayed in the citation interface.

In some embodiments, the displaying, in a citation interface, information at a first location in a target search result in operation 103 is implemented by using the following technical solution: positioning, in the citation interface, the first location in the target search result, and displaying the information at the first location (the information herein includes the target key information). For example, the citation interface can be configured to display a content on a single page in the search result. Usually, the first page in the search result is preferentially displayed when the search result is displayed by jumping. In this embodiment of this disclosure, when the target key information is in the fourth row on the second page, the first location herein is the fourth row on the second page. In response to the trigger operation for the target citation tag, the fourth row on the second page is determined in a manner of anchor point positioning, and then information in the fourth row on the second page in the target search result is displayed in the citation interface.

As an example, the target citation tag is derived from at least one citation tag, the target key information is key information corresponding to the target citation tag, the target key information corresponds to the target search result, and the target key information is derived from the target search result, or the target key information is obtained by performing semantic generation processing based on a key content in the target search result. Referring to FIG. 4A, a question 401A (session information included in the first message) and an answer 402A (session information included in the second message) are displayed in a human-computer interaction interface. The answer 402A includes an answer content 403A (key information) and a citation tag 404A. In response to a trigger operation for the citation tag 404A, a reference source window (that is, a citation interface) pops up in the human-computer interaction interface, and the answer content 403A is displayed in the reference source window. The reference source window is configured to display a citation source of the answer content 403A. The citation source may be an article or a web page. However, after the citation tag is triggered, a first location related to the answer content 403A in the citation source is directly positioned and target key information located at the first location in the citation source is displayed. In a case that a display area of the citation interface is insufficient to display all information in the search result, the target key information in the target search result can be displayed in the display area of the citation interface by positioning to the first location. In a case that the display area of the citation interface is sufficient to display all information in the search result, the target key information in the target search result can be displayed in a center display area of the citation interface by positioning to the first location.

As an example, the target key information herein is related to an original content at the first location in the target search result. For example, the target key information may be directly copied from the original content at the first location in the target search result, or the target key information may be obtained by summarizing the original content at the first location in the target search result.

In some embodiments, the target key information further has another citation tag, and when the information at the first location in the target search result is displayed in the citation interface, an tag control corresponding to the another citation tag is displayed. In response to a trigger operation for the tag control of the another citation tag, information at a second location in another target search result is displayed in the citation interface. The information at the second location includes the target key information, and the another target search result is a search result associated with a source link of the another citation tag. According to this embodiment of this disclosure, a quick viewing effect can be achieved. In this way, there is no need to return to the session interface again for clicking and jumping, thereby improving human-computer interaction efficiency.

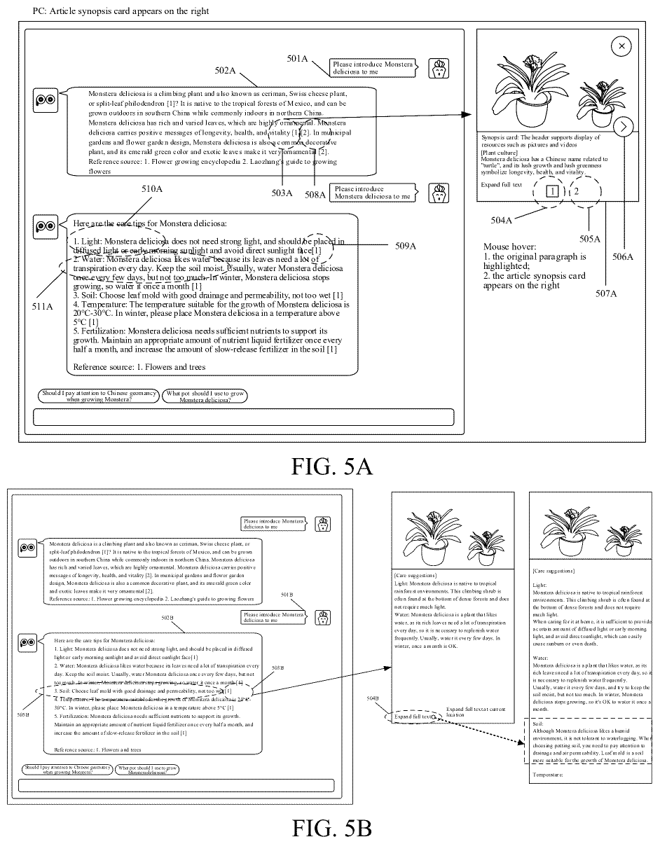

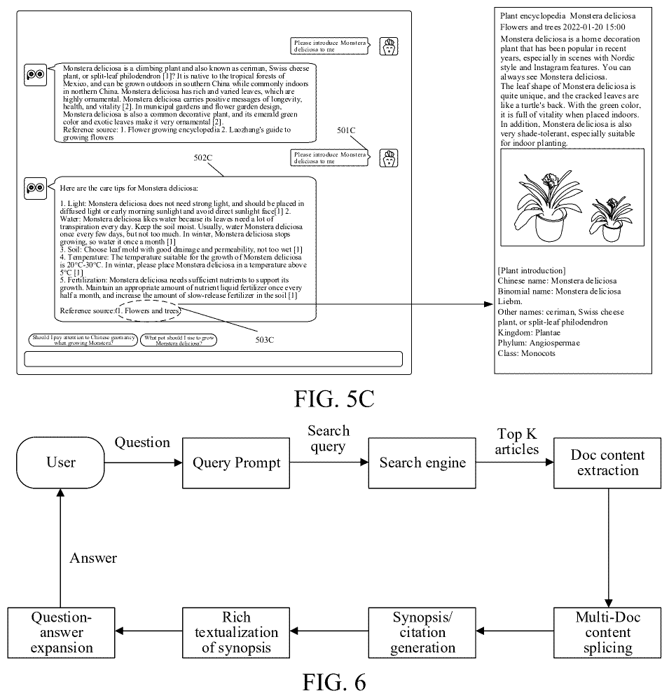

As an example, referring to FIG. 5A, a question 501A (session information included in the first message) and an answer 502A (session information included in the second message) are displayed in a human-computer interaction interface. The answer 502A includes an answer content, a citation tag 503A corresponding to the answer, and a citation tag 508A. In response to a trigger operation for the target citation tag 503A, because a citation source corresponding to the triggered citation tag 503A is “Flower growing encyclopedia”, a first location of the target key information (key information corresponding to the citation tag 503A) in the target search result (“Flower growing encyclopedia” corresponding to the citation tag 503A) may be positioned in a synopsis card for display. The key information corresponding to the citation tag 503A actually hits two citation sources, which are “Flower growing encyclopedia” and “Laozhang's guide to growing flowers”, respectively. Therefore, an tag control 505A corresponding to the other citation tag 508A may be simultaneously displayed in the synopsis card. In response to a trigger operation for the tag control 505A of the other citation tag, a second location of the target key information (key information corresponding to the target citation tag 503A) in the other target search result (“Laozhang's guide to growing flowers” corresponding to the citation tag 508A) is positioned for display. The second location herein is a location of a citation reference content of the target key information in the other target search result.

In some embodiments, the second message includes an associated citation tag having a same tag sequence number as the target citation tag. When the information at the first location in the target search result is displayed in the citation interface, a jump control corresponding to the associated citation tag is displayed. Information at a third location in the target search result is displayed in the citation interface in response to a trigger operation for the jump control. The information at the third location includes key information corresponding to the associated citation tag. According to this embodiment of this disclosure, a quick viewing effect can be achieved. In this way, there is no need to return to the session interface again for clicking and jumping, thereby improving human-computer interaction efficiency.

As an example, referring to FIG. 5A, a question (session information included in the first message) and an answer (session information included in the second message) are displayed in a human-computer interaction interface. The answer includes key information 510A, key information 511A, and a citation tag 509A. In response to a trigger operation for the target citation tag 509A, a first location of the target key information (the key information 510A) in a target search result (“Flowers and trees” corresponding to the target citation tag 509A) may be positioned in a synopsis card for display. Because the target citation tag 509A corresponds to both the key information 510A and the key information 511A, a jump control corresponding to the other piece of key information 511A may also be displayed in the synopsis card. In response to a trigger operation for the jump control of the other piece of key information 511A, a third location of the other piece of key information (the key information 511A) in the target search result (“Flowers and trees”) is positioned for display.

In some embodiments, the second message also includes a source link of each citation tag. Referring to FIG. 3B, operation 104 shown in FIG. 3B may be further performed.

Operation 104: Display, in response to a trigger operation for a source link of any citation tag, a search result associated with the source link of the any citation tag.

As an example, key information corresponding to the any citation tag corresponds to the search result associated with the source link of the any citation tag, and it represents that the key information corresponding to the any citation tag is directly derived from the search result associated with the source link of the any citation tag, or the key information corresponding to the any citation tag is obtained by performing semantic generation processing based on a key content in the search result associated with the source link of the any citation tag. Referring to FIG. 4C, a human-computer interaction interface displays a question 401C (session information included in the first message) and an answer 402C (session information included in the second message), and the answer 402C further includes a link 403C (a source link of a citation tag 405C) of a citation source. In response to a trigger operation for the source link 403C, a reference source window pops up in the human-computer interaction interface, and a search result 404C associated with the source link is displayed in the reference source window, that is, the full text of the citation source may be displayed in the reference source window. According to the embodiments of this disclosure, source viewing efficiency can be improved.

In some embodiments, if key information corresponding to a plurality of citation tags is derived from a same search result, the plurality of citation tags have a same tag sequence number. The tag sequence number of any of the citation tags is the same as a source link sequence number of a source link corresponding to the any citation tag.

As an example, referring to FIG. 4A, the answer in FIG. 4A includes two citation tags having an tag sequence number of 2, and the two citation tags have a same citation source “Laozhang's guide to growing flowers”, and therefore correspond to a same source link. The citation tag and the source link are displayed in the answer, and the citation tag and the source link that correspond to each other have a same sequence number. For example, a source link sequence number of the source link of “Laozhang's guide to growing flowers” is the same as an tag sequence number of a citation tag corresponding to key information cited from “Laozhang's guide to growing flowers”, so that a user can directly obtain a correspondence between key information and a citation source by using a same sequence number.

In some embodiments, the displaying, in the session interface, a second message for replying to the first message in operation 102 may be implemented by using the following technical solution: displaying key information in the first message in a third display manner, and displaying other information in the second message than the key information in a fourth display manner different from the third display manner. This embodiment of this disclosure enables a user to quickly focus on key information, thereby improving human-computer interaction efficiency.

As an example, for the display of the second message, key information and non-key information may be displayed in a differentiated display manner. The key information is information that has a citation source and that is configured for replying to the first message, while the non-key information is information that exists to make the second message have a complete and coherent meaning. Herein, both the key information and the non-key information may be displayed in the fourth display manner. In response to a mouse hover operation for any citation tag, key information corresponding to the any citation tag is displayed based on the third display manner. In response to ending of the mouse hover operation, displaying, in the fourth display manner, the key information corresponding to the any citation tag is resumed.

In some embodiments, referring to FIG. 3C, displaying a first message in the session interface in response to a message transmission operation in operation 102 may be implemented through operation 1021 and operation 1022 shown in FIG. 3C.

Operation 1021: Display at least one piece of association information in the session interface, the association information being related to session information included in a recent history message in the session interface.

As an example, the recent history message herein is the last message displayed in the session interface. Referring to FIG. 4D, a question 401D and an answer 402D are displayed in a human-computer interaction interface. The answer 402D herein is the recent history message.

Operation 1022: Identify, in response to a trigger operation for any piece of association information, the trigger operation as the message transmission operation, and add the any piece of association information to the first message for display.

As an example, still referring to FIG. 4D, the human-computer interaction interface further displays an association question 403D (association information). The association question 403D is obtained by means of association based on the question 401D and the answer 402D. The history first message and the history second message herein are recent history messages. In response to a trigger operation for the association question 403D, the trigger operation is identified as a message transmission operation, and any piece of association information is added to the first message for display. That is, the association question 403D is displayed in the human-computer interaction interface. This embodiment of this disclosure can provide session guidance, thereby improving human-computer interaction efficiency.

In some embodiments, the displaying, in a citation interface, information at a first location in a target search result in operation 103 may be implemented by using the following technical solution: displaying the target key information in a first display manner; and displaying other information in the information at the first location than the target key information in a second display manner different from the first display manner. This embodiment of this disclosure enables a user to quickly focus on key information, thereby improving human-computer interaction efficiency.

As an example, when the information at the first location in the target search result is displayed in the citation interface, the target key information and the other information may be displayed in a differentiated display manner. The target key information is key information corresponding to the triggered citation tag, and the other information is information in the target search result other than the target key information as a citation source.

In some embodiments, the displaying, in a citation interface, information at a first location in a target search result in operation 103 may be implemented by using the following technical solution: displaying a partial content of the target search result; and displaying, in the citation interface, the information at the first location in the target search result in response to an expand operation for the target search result. According to this embodiment of this disclosure, display resources can be saved and utilization of the display resources can be improved.

As an example, referring to FIG. 5B, a question 501B (session information included in the first message) and an answer 502B (session information included in the second message) are displayed in a human-computer interaction interface. The answer 502B includes an answer content (key information) and a citation tag 503B. In response to a trigger operation for the citation tag 503B, a citation source “Flowers and trees” corresponding to the citation tag 503B is displayed in a synopsis card. The citation source herein is the target search result, and only some information of the target search result is displayed herein. An expand full text control 504B is also displayed in the synopsis card. In response to a trigger operation (an expand operation) for the expand full text control 504B, after the full text is expanded, anchor point alignment is performed to position a segment location (a first location) of the corresponding answer content (target key information) in the full text of the citation source “Flowers and trees”. The synopsis card in FIG. 5B may be displayed on the right side of the session interface, as shown in FIG. 5A.

In some embodiments, during the display of the partial content of the target search result, when there are a plurality of citation tags of the target key information, a target tag control in a selected state and another tag control are displayed in the citation interface in which the target search result is displayed, a control sequence number of the target tag control being the same as an tag sequence number of the triggered target citation tag. A partial content of another target search result is displayed when the another tag control is in the selected state, a control sequence number of the another tag control being the same as an tag sequence number of another citation tag of the target key information, and the target key information being corresponding to the another target search result. According to this embodiment of this disclosure, quick switching can be performed, thereby improving query efficiency.

As an example, referring to FIG. 5A, a question 501A and an answer 502A are displayed in a human-computer interaction interface. The answer 502A includes an answer content and a citation tag 503A. In response to a trigger operation for the citation tag 503A (or in response to hovering of a mouse over the citation tag 503A, or in response to hovering of a mouse over the answer content corresponding to the citation tag 503A), a synopsis card 507A pops up on the right side of the session interface, and the answer content corresponding to the citation tag 503A is highlighted in the answer 502A. A citation source of the answer content corresponding to the citation tag 503A is displayed in the synopsis card 507A. A location related to the answer content in the citation source is not directly positioned herein. The answer 502 actually hits two citation sources: “Flower growing encyclopedia” and “Laozhang's guide to growing flowers”, respectively. Because the citation source corresponding to the triggered citation tag 503A is “Flower growing encyclopedia”, a citation source sequence number 504A corresponding to “Flower growing encyclopedia” in the synopsis card 507A is in a selected state, that is, the citation source being displayed in the synopsis card 507A is “Laozhang's guide to growing flowers”. In response to a trigger operation for a page turning control 506A, an adjacent citation source sequence number 505A is in the selected state, and the citation source “Laozhang's guide to growing flowers” that corresponds to the corresponding citation source sequence number 505A is displayed in the synopsis card 507A.

In some embodiments, referring to FIG. 3D, before the displaying, in the session interface, a second message for replying to the first message, operation 105 to operation 107 may be further performed.

Operation 105: Perform semantic decomposition processing on session information included in the first message to obtain query information matching the first message.

As an example, herein, the semantic decomposition processing may be performed by using a semantic generation model, or the semantic decomposition processing may be performed by using a natural language processing technology. When the semantic decomposition processing is performed by using the semantic generation model, the following task templates may be used to arrange a task for a generative language model: “You are a query understanding assistant. List queries suitable for retrieval according to my task, and output each query within a pair of {}. Task: Identify a most important requirement when a user searches for “% s”, and output only one retrieval query that can meet this requirement”. “% s” is replaced with a question input by the user, and the generative language model generates a query statement corresponding to the question. The semantic generation model may be caused to output the query information matching the first message by inputting the task template to the semantic generation model. For example, the first message may be “I would like to learn Frisbee”, and the query information matching the first message may be “How to learn Frisbee”.

Operation 106: Perform search processing based on the query information to obtain a plurality of candidate search results.

In some embodiments, the performing search processing based on the query information to obtain a plurality of candidate search results in operation 106 may be implemented by using the following technical solution: invoking a search engine to obtain a plurality of original search results matching the query information; and sorting the plurality of original search results in descending order based on a relevance between each of the original search results and the first message, and using at least one search result that ranks top as a candidate search result.

In some embodiments, before the sorting the plurality of original search results in descending order based on a relevance between each of the original search results and the first message, the following processing is performed for each of the original search results: performing word segmentation processing on the session information included in the first message and the query information to obtain a plurality of first word segmentation results, and performing query understanding processing on the plurality of first word segmentation results to obtain first understanding information; performing word segmentation processing on each segment of the original search result to obtain a plurality of second word segmentation results, and performing query understanding processing on the plurality of second word segmentation results to obtain second understanding information of each segment; determining an understanding query relevance between the first understanding information and each piece of the second understanding information; and using highest understanding query relevance as the relevance between the original search result and the first message.

As an example, at a search result relevance filtering stage, an understanding manner of natural language processing may be used to invoke an understanding capability of a natural language processing technology for a question input by a user and a query statement extracted by a generative language model. Word segmentation and word weight and tightness calculation are performed on the question (session information) and the query statement to obtain first understanding information. Word segmentation and word weight and tightness calculation are also performed on a search result title and segments of the full text (the original search result) to obtain second understanding information. The word weight calculation and the tightness calculation herein are technical means of a query understanding branch in a search scenario. Based on this, relevance (understanding query relevance) between the question and each segment of the search result may be obtained through text relevance or vector semantic relevance calculation. Relevance of the full search result is determined by a maximum value of the relevance of the included segments. A full search result with a high relevance is retained. Alternatively, relevance determining may be performed on the segments of the search result by using a generative language model, for example, by using the following prompt template: “Do you think “% answer” is a correct answer to the question “% quest ”? If yes, please return “yes”, or if no, please return “no””.

Operation 107: Extract, from the plurality of candidate search results, at least one key content related to the first message, and perform text generation processing on the at least one key content to obtain the second message for replying to the first message.

In some embodiments, each piece of key information corresponds to at least one key content, and the extracting, from the plurality of candidate search results, at least one key content related to the first message in operation 107 may be implemented by using the following technical solution: performing the following processing for each of the candidate search results: performing segmentation processing on the candidate search result to obtain a plurality of segments; obtaining a semantic relevance between each of the segments and the first message; sorting the plurality of segments in descending order based on the semantic relevance of the plurality of segments to obtain at least one segment ranking top as a candidate segment; and performing, for each candidate segment, front-back extension processing with a set window length in a candidate search result corresponding to the candidate segment to obtain an extended segment of each candidate segment, and using the extended segment as a key content corresponding to the candidate search result. According to this embodiment of this disclosure, a relevance between a key content and a question can be improved, thereby improving accuracy of an answer.

As an example, at a search result segment extraction stage, in a process of calculating relevance between a search result and an input question, a segment with a high relevance between a search result full text content and the input question may be obtained. Front-back main text extension is performed on each segment in an original text with a window whose length is set according to a requirement, to obtain each extended segment, and a score value of relevance between the segment before the extension and the input question is used as relevance between the extended segment and the input question. After being obtained, relevance extended segments of a plurality of search results are sorted according to relevance values to obtain search result segments having highest relevance.

In some embodiments, the foregoing performing text generation processing on the at least one key content to obtain the second message for replying to the first message may be implemented by using the following technical solution: performing combination processing on the at least one key content to obtain a combination result; and performing natural language text generation processing on the combination result to obtain the second message for replying to the first message.

As an example, at a search result segment slicing stage: A quantity of segments extracted from each search result is set, the segments of each search result are retained in descending order of relevance values, and the search results corresponding to the segments are numbered correspondingly. For example, a segment of the first search result is numbered 1, and the segments are numbered in sequence thereafter. Segment texts are spliced together, and numbers of the corresponding segment texts are added to a spliced content. For example, a segment 1 (whose content is xxxxxxx) and a segment 2 (whose content is yyyyyy) are extracted from an article 1, and a segment 3 (whose content is zzzzzz) is extracted from an article 2. In this case, the spliced content is xxxxxxx[1]yyyyyy[1]zzzzzz[2]. The combined content herein is actually a combination result of the key content, and the key content may be converted into key information through natural language text generation processing, enabling an answer to be personified and consistent with a regular language expression habit.

As an example, the natural language text generation processing may be implemented by using a generative language model: The combination result is input into the generative language model for answer generation, and the following task assignment template may be used: “Generate an answer of no more than 400 words according to a search term “% s” of a user and the following paragraphs, and use \ “[Arabic numeral]\” for citation to indicate a paragraph from which each sentence is derived. Provide the citation only, not comments. Do not citation a paragraph with a poor relevance, and replace “% s” with a question input by the user; or extract information based on the following content, with the objective of answering the question “% s” as perfectly as possible. Discard irrelevant information. Make sure the answer is smooth and in a clear format. Use \“[numeral]\” for citation to indicate respectively a number of a paragraph from which each sentence in your reply is derived. Provide the citation only, not comments. Do not citation a paragraph with a poor relevance”.

In some embodiments, the foregoing performing combination processing on the at least one key content to obtain a combination result may be implemented by using the following technical solution: performing numbering processing on a candidate search result corresponding to each key content to obtain a search result number of each candidate search result; performing splicing processing on the at least one key content to obtain a splicing result, and adding a corresponding citation tag to each key content in the splicing result; and obtaining location marking information corresponding to the key content in the candidate search result from which the key content is derived, and adding the location marking information to the citation tag of the corresponding key content to obtain the combination result; an tag sequence number of the citation tag being the same as the search result number of the candidate search result from which the corresponding key content is derived.

As an example, the citation tag is clicked to jump to a corresponding segment location through anchor point alignment (a location at which a reference content of the key information is located). According to a recorded mapping relationship between the tag sequence number of the citation tag and a corresponding article (the search result), in combination with a location of a citation segment (the key information) in the article, the citation tag is actually a URL link of the article, and corresponding location marking information may be spliced to the URL link of the article as an html <a href> tag of the citation tag. The corresponding segment location may be jumped to when the citation tag is clicked.

The following describes an application of the embodiments of this disclosure in an actual application scenario.

In some embodiments, a terminal of a target object displays a session interface and receives a message transmission operation. A first message is displayed in the session interface of the terminal. The terminal transmits the first message to a server. The server obtains a second message for replying to the first message. The second message includes key information for replying to the first message and a citation tag of each piece of key information. The server returns the second message to the terminal, and the second message is displayed in the session interface of the terminal. The terminal receives a trigger operation for a target citation tag, generates a source viewing request based on the trigger operation, and transmits the source viewing request to the server. The server obtains a target search result corresponding to the target citation tag, and obtains a first location that is of key information corresponding to the target citation tag and that is in the target search result. The server returns the first location and the target search result to the terminal. Information at the first location in the target search result is displayed in a citation interface of the terminal.

In some embodiments, a question is input through a dialog entry, and a generated answer is returned after back-end processing is performed. A citation source of a corresponding answer content is marked on a text of the answer, and a reference source is attached to the answer. Meanwhile, the question and answer are actively extended below the answer to provide a guidance prompt for a next question. In response to a trigger operation for the citation source, a corresponding article link may be opened, and a segment location of the related citation is jumped to through anchor point alignment for highlighting. The full text of the article of the reference source is directly opened in response to a trigger operation for the reference source. A new round of dialog process is carried out in response to a trigger operation for the next question of the active extension.

In some embodiments, referring to FIG. 4A, a question 401A and an answer 402A are displayed in a human-computer interaction interface. The answer 402A includes an answer content 403A and a citation tag 404A. In response to a trigger operation for the citation tag 404A, a reference source window pops up in the human-computer interaction interface, and the answer content 403A is displayed in the reference source window in an emphasized manner (for example, highlighted). Herein, the reference source window may be actually configured for displaying a source article of the answer content 403A, but after the citation tag is triggered, a location of the answer content 403A in the source article is directly positioned for display.

In some embodiments, referring to FIG. 4B, a question 401B and an answer 402B are displayed in a human-computer interaction interface. The answer 402B includes an answer content 403B and a citation tag 404B. In response to a trigger operation for the citation tag 404B, a reference source window pops up in the human-computer interaction interface, and the answer content 403B is displayed in the reference source window in an emphasized manner (for example, highlighted). Herein, the reference source window may be actually configured for displaying a source article of the answer content 403B, but after the citation tag is triggered, a location of the answer content 403B in the source article is directly positioned for display.

In some embodiments, referring to FIG. 4C, a question 401C and an answer 402C are displayed in a human-computer interaction interface, and the answer 402C further includes a source link 403C of a citation source. In response to a trigger operation for the link 403C, a reference source window pops up in the human-computer interaction interface, and a search result 404C associated with the source link 403C is displayed in the reference source window, that is, a full text of the citation source may be displayed in the reference source window.

In some embodiments, referring to FIG. 4D, a question 401D and an answer 402D are displayed in a human-computer interaction interface. The human-computer interaction interface further displays an association question 403D. The association question 403D is obtained by means of association based on the question 401D and the answer 402D. In response to a trigger operation for the association question 403D, the association question 403D is displayed in the human-computer interaction interface, and an association answer 404D corresponding to the association question 403D is displayed.

In some embodiments, referring to FIG. 5A, a question 501A and an answer 502A are displayed in a human-computer interaction interface. The answer 502A includes an answer content and a citation tag 503A. In response to a trigger operation for the citation tag 503A (or in response to hovering of a mouse over the citation tag 503A, or in response to hovering of a mouse over the answer content corresponding to the citation tag 503A), a synopsis card 507A pops up on the right side of the session interface, and the answer content corresponding to the citation tag 503A is highlighted in the answer 502A. A citation source of the answer content corresponding to the citation tag 503A is displayed in the synopsis card 507A. A location related to the answer content in the citation source is not directly positioned herein. The answer 502 actually hits two citation sources: “Flower growing encyclopedia” and “Laozhang's guide to growing flowers”, respectively. Because the citation source corresponding to the triggered citation tag 503A is “Flower growing encyclopedia”, a citation source sequence number 504A corresponding to “Flower growing encyclopedia” in the synopsis card 507A is in a selected state, that is, the citation source being displayed in the synopsis card 507A is “Laozhang's guide to growing flowers”. In response to a trigger operation for a page turning control 506A, an adjacent citation source sequence number 505A is in the selected state, and the citation source “Laozhang's guide to growing flowers” that corresponds to the corresponding citation source sequence number 505A is displayed in the synopsis card 507A.

In some embodiments, referring to FIG. 5B, a question 501B and an answer 502B are displayed in a human-computer interaction interface. The answer 502B includes an answer content and an citation tag 503B. In response to a trigger operation for the citation tag 503B, a citation source “Flowers and trees” corresponding to the citation tag 503B is displayed in a synopsis card, and an expand full text control 504B is displayed in the synopsis card. In response to a trigger operation for the expand full text control 504B, after the full text is expanded, anchor point alignment is performed to position a segment location of the corresponding answer content in the full text of the citation source “Flowers and trees”. The synopsis card in FIG. 5B may be displayed on the right side of the session interface, as shown in FIG. 5A.

In some embodiments, referring to FIG. 5C, a question 501C and an answer 502C are displayed in a human-computer interaction interface. The answer 502C includes a citation source 503C. In response to a trigger operation for the citation source 503C, the full text of the citation source is displayed.

In some embodiments, referring to FIG. 6, first, a terminal transmits, to a session server ChatSvr, a question input by a user. The ChatSvr invokes a generative language model to extract, from the question, a query statement matching the question; invokes a search engine system to perform a query based on the extracted query statement to obtain search results, and obtains top search results from all the search results; calculates relevance between the full text of a title of each of the top search results and the question, and retains a most related search result; extracts a full text content of the retained top search result, and a plurality of segments may be extracted from each top search result; splices, according to a template for generating an abstract, a plurality of segments obtained by extracting a plurality of articles, and marks the segments with tag sequence numbers of original text citation tags, to form an abstract input text; records, when marking the tag sequence numbers of the original text citation tags, original text segments and original text links corresponding to the numbers; and uses the abstract input text as an input of the generative language model. The generative language model generates a corresponding answer abstract content, and returns, in the answer abstract content, an tag sequence number of a corresponding citation tag. A text content corresponding to the tag sequence number of the citation tag is extracted from the answer outputted by the generative language model. Text semantic matching is performed according to an original text segment corresponding to the recorded tag sequence number of the citation tag. If the matching succeeds, the citation tag is retained, and a corresponding <a href=“https://xxx”>html tag is added to a plain text of the corresponding citation tag, to add a citation source link. The retained top search result is used as a reference source, and a corresponding html<a> tag is added to the answer to form a hyperlink text. The generative language model is invoked according to the question and the answer to obtain a next extended question-answer question.

In some embodiments, a specific manner of extracting, from the question, the query statement matching the question is as follows. The following prompt template may be used to arrange a task for the generative language model: “You are a query understanding assistant. List queries suitable for retrieval according to my task, and output each query within a pair of {}. Task: Identify a most important requirement when a user searches for “% s”, and output only one retrieval query that can meet this requirement”. “% s” is replaced with a question input by the user, and the generative language model generates a query statement corresponding to the question.

In some embodiments, at a search result relevance filtering stage, an understanding manner of natural language processing may be used to invoke an understanding capability of a natural language processing technology for a question input by a user and a query statement extracted by a generative language model. Word segmentation and word weight and tightness calculation are performed on the question and the query statement. Word segmentation and word weight and tightness calculation are also performed on a search result title and segments of the full text to obtain understanding information at the query and original text word segmentation level. Based on this, relevance between the question and each segment of the search result may be obtained through text relevance or vector semantic relevance calculation. Relevance of the full search result is determined by a maximum value of the relevance of the included segments. A full search result with a high relevance is retained. Alternatively, relevance determining may be performed on the segments of the search result by using a generative language model, for example, by using the following prompt template: “Do you think “% answer” is a correct answer to the question “% quest”? If yes, please return “yes”, or if no, please return “no””.

In some embodiments, at a search result segment extraction stage, in a process of calculating relevance between a search result and an input question, a segment with a high relevance between a search result full text content and the input question may be obtained. Front-back main text extension is performed on each segment in an original text with a window whose length is set according to a requirement, to obtain each extended segment, and a score value of relevance between the segment before the extension and the input question is used as relevance between the extended segment and the input question. After being obtained, relevance extended segments of a plurality of search results are sorted according to relevance values to obtain search result segments having highest relevance.

In some embodiments, at a search result segment slicing stage: A quantity of segments extracted from each search result is set, the segments of each search result are retained in descending order of relevance values, and the search results corresponding to the segments are numbered correspondingly. For example, a segment of the first search result is numbered 1, and the segments are numbered in sequence thereafter. Segment texts are spliced together, and numbers of the corresponding segment texts are added to a spliced content. For example, a segment 1 (whose content is xxxxxxx) and a segment 2 (whose content is yyyyyy) are extracted from an article 1, and a segment 3 (whose content is zzzzzz) is extracted from an article 2. In this case, the spliced content is xxxxxxx[1]yyyyyy[1]zzzzzz[2].

In some embodiments, at an answer generation stage of the generative language model: the spliced content is input into the generative language model for answer generation, and the following task assignment template may be used:

“Generate an answer of no more than 400 words according to a search term “% s” of a user and the following paragraphs, and use \“[Arabic numeral]\” for citation to indicate a paragraph from which each sentence is derived. Provide the citation only, not comments. Do not citation a paragraph with a poor relevance, and replace “% s” with a question input by the user;
or extract information based on the following content, with the objective of answering the question “% s” as perfectly as possible. Discard irrelevant information. Make sure the answer is smooth and in a clear format. Use \“[numeral]\” for citation to indicate respectively a number of a paragraph from which each sentence in your reply is derived. Provide the citation only, not comments. Do not citation a paragraph with a poor relevance”.

In some embodiments, at a question expansion stage, the following task assignment template may be used: “You are a query understanding assistant. List query statements suitable for retrieval according to my task, and output each query statement within a pair of {}. Task: Identify a description subject and a hot requirement related thereto when a user searches for “% s”, ask a question that can meet the requirement, and list three query statements”.

In some embodiments, the citation tag is clicked to jump to a corresponding segment location through anchor point alignment. According to a recorded mapping relationship between the tag sequence number of the citation tag and a corresponding article, and in combination with a location of a citation segment in the article, corresponding location marking information may be spliced to a URL link of the article as an html <a href> tag of the citation tag. The corresponding segment location may be jumped to when the citation tag is clicked.

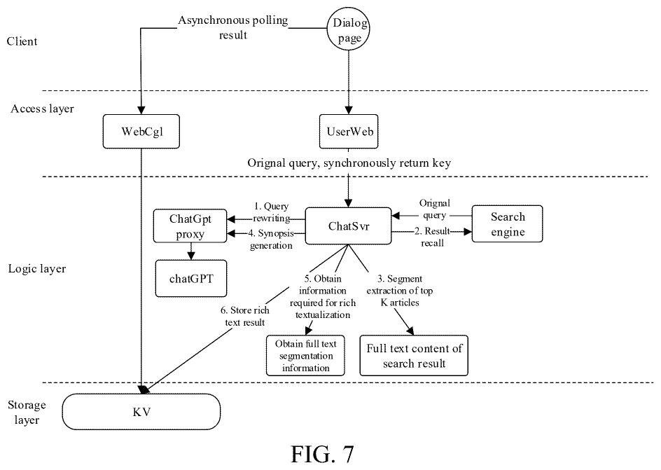

In some embodiments, referring to FIG. 7, in an interaction process, because an entire process consumes a long time, after a user enters a dialog, a back end triggers an entire answer generation processing process, and a client and the back end check, by using an asynchronous polling process, whether an answer is generated at the back end. During implementation, after entering a question, the user invokes UserWeb to transmit a first message to ChatSvr, and returns key data corresponding to the first message to a dialog page. After the first message transmitted to ChatSvr by invoking, ChatSvr performs the following processing: 1. ChatSvr invokes a generative language model proxy to rewrite session information in the first message as query information. 2. ChatSvr invokes a search engine to perform search processing based on the query information to obtain a search result. 3. ChatSvr extracts segments from top K articles based on a content of the full text of the search result. 4. ChatSvr inputs the extracted segments to the generative language model proxy to obtain an abstract for replying. 5. ChatSvr obtains segment location information required for rich textualization based on full-text segmentation location information. 6. ChatSvr generates rich text information based on the determined location information, and uses the rich text information as value data, and stores the value data together with the key data of the first message in a key-value pair. The dialog page queries for the value data corresponding to the key data by using WebCgl in a manner of asynchronous polling, and the value data is returned to the dialog page.

After an answer is generated, <user, questionid> is used as a key, the answer is written as a value into KV for storage, and the key is returned to the client. The client invokes WebCGI by using the key at a time interval to obtain a corresponding answer by polling, and the WebCGI invokes KV at the back end to obtain the generated answer.

According to this embodiment of this disclosure, a segment is extracted according to a search result having a high relevance, to generate a final answer, thereby improving accuracy of the generated answer. In addition, a corresponding citation tag and a corresponding reference source are provided, so that reliability of the answer can be further confirmed. Segment extraction and splicing are performed on the full text of the search result and then a generative language model is invoked, so that a quantity of input tokens for each interaction by the generative language model can be reduced, and result segments can be input into the generative language model as many as possible, thereby ensuring input richness of the generative language model. An answer is generated based on extracted content segments, and the extracted content segments are controllable, thereby ensuring as much as possible that the generated answer content is not highly summarized by the generative language model.

According to this embodiment of this disclosure, a query prompt is performed on an input question by using the generative language model to obtain a core query statement, or semantic understanding and extraction or rewriting may be performed on the input question by using a natural language understanding technology to obtain a query statement. In this embodiment of this disclosure, the generative language model performs the query prompt on the input question to obtain the query statement, and each query statement is searched for and then summarized as a whole to obtain a search result with a high relevance. In this embodiment of this disclosure, direct text splicing is used to obtain an input for generating an answer, or a more structured splicing manner may be used.

This embodiment of this disclosure provides an interactive dialog product combining searching and the generative language model. A user submits a question, and a client obtains a final answer through back-end processing, returns the final answer to the user, and provides a citation source in a description of the answer. The user may click on the citation source to pop up a page of an article of the citation source in a dialog box and anchor the page to a specific location of the article. In addition, a related question is further extended in combination with the question and the answer, and a new question-answer dialog procedure is triggered after the user clicks on the related question. During the back-end processing, the question of the user is rewritten and converted into a search query statement, and top few results most related to the question are extracted after retrieval. Segments are separately extracted from the top results and then spliced into complete texts and transmitted to the generative language model for generation of the final answer and citation tag. According to this embodiment of this disclosure, a plain text dialog form of the generative language model is improved to a rich text form, and in combination with the search result, the corresponding citation tag is provided, thereby improving normativeness and credibility of the generated answer.

In the embodiments of this disclosure, related data such as user information is involved. When the embodiments of this disclosure are applied to a specific product or technology, user permission or consent needs to be obtained, and collection, use, and processing of the related data need to comply with relevant laws, regulations, and standards of relevant countries and regions.

The following continues to describe a structure in which an information processing apparatus 455 provided in the embodiments of this disclosure is implemented as a software module. In some embodiments, as shown in FIG. 2, the software module in the information processing apparatus 455 stored in the memory 450 may include: a display module 4551, configured to display a session interface; a session module 4552, configured to display a first message in the session interface in response to a message transmission operation, and display, in the session interface, a second message for replying to the first message; the second message including key information for replying to the first message and a citation tag of each piece of key information, and the key information being corresponding to a search result associated with the citation tag; and a jump module 4553, configured to display a citation interface and display, in the citation interface, information at a first location in a target search result in response to a trigger operation for a target citation tag, target key information being key information corresponding to the target citation tag, and the target key information being corresponding to the target search result corresponding to the target citation tag.

In some embodiments, the target key information further has another citation tag, and when the information at the first location in the target search result is displayed in the citation interface, the jump module 4553 is further configured to: display an tag control corresponding to the another citation tag; and display, in the citation interface, information at a second location in another target search result in response to a trigger operation for the tag control of the another citation tag, the information at the second location including the target key information, and the another target search result being a search result associated with a source link of the another citation tag.

In some embodiments, when the information at the first location in the target search result is displayed in the citation interface, the jump module 4553 is further configured to: display a jump control corresponding to an associated citation tag; and display, in the citation interface, information at a third location in the target search result in response to a trigger operation for the jump control, the information at the third location including key information corresponding to the associated citation tag.

In some embodiments, the second message also includes a source link of each citation tag, and the jump module 4553 is further configured to: display, in response to a trigger operation for a source link of any citation tag, a search result associated with the source link of the any citation tag; key information corresponding to the any citation tag being corresponding to the search result associated with the source link of the any citation tag.

In some embodiments, if key information corresponding to a plurality of citation tags is derived from a same search result, the plurality of citation tags have a same tag sequence number. The tag sequence number of any of the citation tags is the same as a source link sequence number of a source link corresponding to the any citation tag.

In some embodiments, the jump module 4553 is further configured to: display the target key information in a first display manner; and display other information in the information at the first location than the target key information in a second display manner different from the first display manner.

In some embodiments, the session module 4552 is further configured to display key information in the first message in a third display manner, and display other information in the second message than the key information in a fourth display manner different from the third display manner.

In some embodiments, the session module 4552 is further configured to display at least one piece of association information in the session interface, the association information being related to session information included in a recent history message in the session interface; and identify, in response to a trigger operation for any piece of association information, the trigger operation as the message transmission operation, and add the any piece of association information to the first message for display.

In some embodiments, the jump module 4553 is further configured to: display a partial content of the target search result; and display, in the citation interface, the information at the first location in the target search result in response to an expand operation for the target search result.

In some embodiments, during the display of the partial content of the target search result, the jump module 4553 is further configured to: display, in the citation interface in which the target search result is displayed, a target tag control in a selected state and another tag control when there are a plurality of citation tags of the target key information, a control sequence number of the target tag control being the same as an tag sequence number of the triggered target citation tag; and display a partial content of another target search result when the another tag control is in the selected state, a control sequence number of the another tag control being the same as an tag sequence number of another citation tag of the target key information, and the target key information being corresponding to the another target search result.

In some embodiments, before the displaying, in the session interface, a second message for replying to the first message, the session module 4552 is further configured to: perform semantic decomposition processing on session information included in the first message to obtain query information matching the first message; perform search processing based on the query information to obtain a plurality of candidate search results; and extract, from the plurality of candidate search results, at least one key content related to the first message, and perform text generation processing on the at least one key content to obtain the second message for replying to the first message.

In some embodiments, the session module 4552 is further configured to invoke a search engine to obtain a plurality of original search results matching the query information; and sort the plurality of original search results in descending order based on a relevance between each of the original search results and the first message, and use at least one search result that ranks top as a candidate search result.

In some embodiments, before the sorting the plurality of original search results in descending order based on a relevance between each of the original search results and the first message, the session module 4552 is further configured to perform the following processing for each of the original search results: performing word segmentation processing on the session information included in the first message and the query information to obtain a plurality of first word segmentation results, and performing query understanding processing on the plurality of first word segmentation results to obtain first understanding information; performing word segmentation processing on each segment of the original search result to obtain a plurality of second word segmentation results, and performing query understanding processing on the plurality of second word segmentation results to obtain second understanding information of each segment; determining an understanding query relevance between the first understanding information and each piece of the second understanding information; and using highest understanding query relevance as the relevance between the original search result and the first message.

In some embodiments, the session module 4552 is further configured to perform the following processing for each of the candidate search results: performing segmentation processing on the candidate search result to obtain a plurality of segments; obtaining a semantic relevance between each of the segments and the first message; sorting the plurality of segments in descending order based on the semantic relevance of the plurality of segments to obtain at least one segment ranking top as a candidate segment; and performing, for each candidate segment, front-back extension processing with a set window length in the candidate search result corresponding to the candidate segment to obtain an extended segment of each candidate segment, and using the extended segment as a key content corresponding to the candidate search result.

In some embodiments, the session module 4552 is further configured to perform combination processing on the at least one key content to obtain a combination result; and perform natural language text generation processing on the combination result to obtain the second message for replying to the first message.

In some embodiments, the session module 4552 is further configured to perform numbering processing on a candidate search result corresponding to each key content to obtain a search result number of each candidate search result; perform splicing processing on the at least one key content to obtain a splicing result, and add a corresponding citation tag to each key content in the splicing result; and obtain location marking information corresponding to the key content in the candidate search result from which the key content is derived, and add the location marking information to the citation tag of the corresponding key content to obtain the combination result; an tag sequence number of the citation tag being the same as the search result number of the candidate search result from which the corresponding key content is derived.

An embodiment of this disclosure provides a computer program product or a computer program, the computer program product including computer-executable instructions, the computer-executable instructions being stored in a computer-readable storage medium. A processor of a computer device reads the computer-executable instructions from the computer-readable storage medium, and the processor executes the computer-executable instructions to cause the computer device to perform the information processing method according to the embodiments of this disclosure.

An embodiment of this disclosure provides a computer-readable storage medium storing computer-executable instructions, the computer-executable instructions, when executed by a processor, causing the processor to perform the information processing method provided in the embodiments of this disclosure, for example, the information processing method shown in FIG. 3A to FIG. 3D.

In some embodiments, the computer-readable storage medium may be a memory such as a FRAM, a ROM, a PROM, an EPROM, an EEPROM, a flash memory, a magnetic surface memory, an optical disk, or a CD-ROM; or may be various devices including one of or any combination of the foregoing memories.

In some embodiments, the computer-executable instructions may be written in the form of a program, software, a software module, a script, or code in any form of programming language (including a compilation or interpretation language, or a declarative or procedural language), and may be deployed in any form, including being deployed as an independent program or being deployed as a module, a component, a subroutine, or another unit suitable for use in a computing environment.

As an example, the computer-executable instructions may, but do not necessarily, correspond to a file in a file system, and may be stored in a part of a file that holds another program or other data, for example, stored in one or more scripts in a HyperText Markup Language (HTML) document, in a single file specially used for a program in discussion, or in a plurality of collaborative files (for example, files storing one or more modules, subprograms, or code sections).

As an example, the computer-executable instructions may be deployed to be executed on one electronic device, on a plurality of electronic devices located at one site, or on a plurality of electronic devices distributed at a plurality of locations and interconnected through a communication network.

According to the embodiments of this disclosure, a citation tag of key information may be displayed in a second message when a first message is automatically replied to, so that a user can view, by using the citation tag, a search result from which the key information is derived, and can locate a location of the key information in the search result for display. In this way, the user does not need to flip up and down in the search result to find the key information, thereby improving information obtaining efficiency and human-computer interaction efficiency.

One or more modules, submodules, and/or units of the apparatus can be implemented by processing circuitry, software, or a combination thereof, for example. The term module (and other similar terms such as unit, submodule, etc.) in this disclosure may refer to a software module, a hardware module, or a combination thereof. A software module (e.g., computer program) may be developed using a computer programming language and stored in memory or non-transitory computer-readable medium. The software module stored in the memory or medium is executable by a processor to thereby cause the processor to perform the operations of the module. A hardware module may be implemented using processing circuitry, including at least one processor and/or memory. Each hardware module can be implemented using one or more processors (or processors and memory). Likewise, a processor (or processors and memory) can be used to implement one or more hardware modules. Moreover, each module can be part of an overall module that includes the functionalities of the module. Modules can be combined, integrated, separated, and/or duplicated to support various applications. Also, a function being performed at a particular module can be performed at one or more other modules and/or by one or more other devices instead of or in addition to the function performed at the particular module. Further, modules can be implemented across multiple devices and/or other components local or remote to one another. Additionally, modules can be moved from one device and added to another device, and/or can be included in both devices.

The use of “at least one of” or “one of” in the disclosure is intended to include any one or a combination of the recited elements. For example, references to at least one of A, B, or C; at least one of A, B, and C; at least one of A, B, and/or C; and at least one of A to C are intended to include only A, only B, only C or any combination thereof. References to one of A or B and one of A and B are intended to include A or B or (A and B). The use of “one of” does not preclude any combination of the recited elements when applicable, such as when the elements are not mutually exclusive.

The foregoing descriptions are merely examples of embodiments of this disclosure and are not intended to limit the scope of this disclosure. Any modification, equivalent replacement, or improvement made within the spirit and scope of this disclosure fall within the scope of this disclosure.

What is claimed is:

1. A method of information processing, the method comprising:
displaying a first message in a session interface in response to a message transmission operation;
displaying, in the session interface, a second message that replies to the first message, the second message including one or more pieces of key information and respective citation tags of the one or more pieces of key information, the one or more pieces of key information being obtained from search results associated with the citation tags; and
displaying, in a citation interface and in response to a trigger operation on a first target citation tag of a target piece of key information in the one or more pieces of key information, first information that is obtained from a first location of a first target search result associated with the first target citation tag, the first information at the first location of the first target search result including the target piece of key information in the second message.

2. The method according to claim 1, wherein:
the second message includes respective source links of the citation tags, and
the method further comprises:
displaying, in response to a trigger operation on a first source link of a first citation tag in the citation tags, a first search result associated with the first source link of the first citation tag, the first search result including at least a first piece of key information in the one or more pieces of key information, and the first piece of key information having the first citation tag in the second message.

3. The method according to claim 2, wherein:
when two or more citation tags of the one or more pieces of key information are derived from a same search result, the two or more citation tags have a same tag sequence number; and
the same tag sequence number indicates a same source link for the two or more citation tags.

4. The method according to claim 1, wherein:
the second message includes an associated piece of key information having an associated citation tag with a same tag sequence number as the first target citation tag; and
the method further comprises:
displaying a jump control element in association with the associated citation tag when the first information is displayed in the citation interface; and
displaying, in the citation interface, third information that is obtained from a third location in the first target search result in response to a trigger operation on the jump control element, the third information at the third location comprising the associated piece of key information.

5. The method according to claim 1, wherein:
the target piece of key information further has a second target citation tag, and
the method further comprises:
displaying a tag control element in association with the second target citation tag when the first information is displayed in the citation interface; and
displaying, in the citation interface, second information that is obtained from a second location of a second target search result in response to a trigger operation on the tag control element, the second information at the second location including the target piece of key information, and the second target search result being associated with a source link of the second target citation tag.

6. The method according to claim 1, wherein the displaying the first information comprises:
displaying the target piece of key information in the first information in a first display manner; and
displaying additional information in the first information other than the target piece of key information in a second display manner, the second display manner being different from the first display manner.

7. The method according to claim 1, wherein the displaying the second message comprises:
displaying the one or more pieces of key information in the second message in a third display manner, and
displaying additional information in the second message other than the one or more pieces of key information in a fourth display manner, the fourth display manner being different from the third display manner.

8. The method according to claim 1, wherein the displaying the first message comprises:
displaying one or more pieces of association information in the session interface, the one or more pieces of association information being related to session information in recent historical messages in the session interface;
identifying, in response to a trigger operation on a piece of association information in the one or more pieces of association information, the trigger operation on the piece of association information to be a new message transmission operation of the piece of association information; and
adding the piece of association information to the first message for display in the session interface.

9. The method according to claim 1, wherein the displaying the first information comprises:
displaying a partial content of the first target search result in the citation interface; and
displaying, in response to an expand operation of the partial content, the first information that is at the first location of the first target search result.

10. The method according to claim 9, wherein the target piece of key information has a plurality of target citation tags including the first target citation tag, the method comprises:
displaying, in the citation interface, a first partial content of the first target search result associated with the first target citation tag when the first target citation tag is triggered;
displaying, in the citation interface, a plurality of tag control elements respectively associated with the plurality of target citation tags in a same sequence as the plurality of target citation tags, a first tag control element associated with the first target citation tag being displayed in a selected state; and
displaying a second partial content of a second target search result associated with a second target citation tag when a second tag control element associated with the second target citation tag is in the selected state.

11. The method according to claim 1, the method further comprising:
performing semantic decomposition processing on session information of the first message to obtain query information matching the first message;
performing search processing based on the query information to obtain a plurality of candidate search results;
extracting, from the plurality of candidate search results, one or more key contents related to the first message; and
performing text generation processing on the one or more key contents to obtain the second message, each piece of key information in the one or more pieces of key information being generated based on at least one key content in the one or more key contents.

12. The method according to claim 11, wherein the performing the search processing comprises:
invoking a search engine to obtain a plurality of original search results matching the query information;
sorting the plurality of original search results in a descending order based on respective relevance measures of the plurality of original search results to the first message; and
selecting a candidate search result from the plurality of original search results according to the descending order.

13. The method according to claim 12, further comprising:
performing word segmentation processing on the session information of the first message and the query information to obtain a plurality of first word segmentation results;
performing query understanding processing on the plurality of first word segmentation results to obtain first understanding information;
performing word segmentation processing on respective sections of an original search result in the plurality of original search results to obtain a plurality of second word segmentation results of the respective sections;
performing query understanding processing on the plurality of second word segmentation results of the respective sections to obtain second understanding information of the respective sections;
determining understanding query relevance measures of the respective sections according the first understanding information and the second understanding information of the respective sections; and
using a highest understanding query relevance measure in the understanding query relevance measures as a relevance measure between the original search result and the first message.

14. The method according to claim 11, wherein the extracting comprises:
performing segmentation processing on a candidate search result in the plurality of candidate search results to obtain a plurality of segments of the candidate search result;
obtaining respective semantic relevance measures of the plurality of segments to the first message;
obtaining one or more candidate segments from the plurality of segments based on the respective semantic relevance measures of the plurality of segments;
performing front-back extension processing with a set window length respective for the one or more candidate segments to obtain one or more extended segments of candidate segment, and
using the one or more extended segments as a key content corresponding to the candidate search result.

15. The method according to claim 11, wherein the performing the text generation processing comprises:
performing combination processing on the one or more key contents to obtain a combination result; and
performing natural language text generation processing on the combination result to obtain the second message for replying to the first message.

16. The method according to claim 15, wherein the performing the combination processing comprises:
performing numbering processing on the plurality of candidate search results to obtain search result numbers respectively for the plurality of candidate search results;
performing splicing processing on the one or more key contents to obtain a splicing result;
adding the citation tags respectively to the one or more key contents in the splicing result;
obtaining respective location markings of the one or more key contents in the plurality of candidate search results, the one or more key contents being derived from the plurality of candidate search results at the respective location markings; and
adding the respective location markings of the one or more key contents to the citation tags of the one or more key contents to obtain the combination result, a tag sequence number of a citation tag in the citation tags being the same as a search result number of a candidate search result of the plurality of candidate search results from which a key content in the one or more key contents is derived.

17. An information processing apparatus, comprising processing circuitry configured to:
display a first message in a session interface in response to a message transmission operation;
display, in the session interface, a second message that replies to the first message, the second message including one or more pieces of key information and respective citation tags of the one or more pieces of key information, the one or more pieces of key information being obtained from search results associated with the citation tags; and
display, in a citation interface and in response to a trigger operation on a first target citation tag of a target piece of key information in the one or more pieces of key information, first information that is obtained from a first location of a first target search result associated with the first target citation tag, the first information at the first location of the first target search result including the target piece of key information in the second message.

18. The information processing apparatus according to claim 17, wherein:
the second message includes respective source links of the citation tags, and
the processing circuitry is configured to:
display, in response to a trigger operation on a first source link of a first citation tag in the citation tags, a first search result associated with the first source link of the first citation tag, the first search result including at least a first piece of key information in the one or more pieces of key information, and the first piece of key information having the first citation tag in the second message.

19. The information processing apparatus according to claim 18, wherein:
when two or more citation tags of the one or more pieces of key information are derived from a same search result, the two or more citation tags have a same tag sequence number; and
the same tag sequence number indicates a same source link for the two or more citation tags.

20. A non-transitory computer-readable storage medium storing instructions which when executed by at least one processor cause the at least one processor to perform:
displaying a first message in a session interface in response to a message transmission operation;
displaying, in the session interface, a second message that replies to the first message, the second message including one or more pieces of key information and respective citation tags of the one or more pieces of key information, the one or more pieces of key information being obtained from search results associated with the citation tags; and
displaying, in a citation interface and in response to a trigger operation on a first target citation tag of a target piece of key information in the one or more pieces of key information, first information that is obtained from a first location of a first target search result associated with the first target citation tag, the first information at the first location of the first target search result including the target piece of key information in the second message.
